(19) United States
(12) Patent Application Publication
(10) Pub. No.: US 2008/0163981 A1
(43) Pub. Date: Jul. 10, 2008

(54) WATER FEED DEVICE FOR AN INCLINED MOISTENER IN A MAIL HANDLING MACHINE

(75) Inventor: Yannick CLARIS, FONTENAY AUX ROSES (FR)

Correspondence Address: SUGHRUE MION, PLLC, 2100 PENNSYLVANIA AVENUE, N.W., SUITE 800, WASHINGTON, DC, 20037, US

(73) Assignee: NEOPOST TECHNOLOGIES, BAGNEUX (FR)

(21) Appl. No.: 11/965,068

(22) Filed: Dec. 27, 2007

(30) Foreign Application Priority Data
Dec. 27, 2006 (FR) 0655977

(51) Int. Cl. B43M 5/04

(52) U.S. Cl. 156/442.2

(57) ABSTRACT

A water feed device for feeding water to a moistener for moistening envelope flaps that is incorporated into a mail handling machine, the water feed device comprising a reserve stock of water from which a quantity of water flows to a reservoir of water, said quantity of water being suitable for imbibing a piece of foam dipping in said reservoir of water, said device having at least two distinct water feed circuits for feeding water separately to two separate compartments of the reservoir of water from two isolated compartments of the reserve stock of water in a manner such as to define two distinct levels of water for the two isolated compartments of the reserve of water, and thus to define two different heights of water in the two corresponding separate compartments of the reservoir of water.

### FIELD OF THE INVENTION

The present invention relates exclusively to the field of mail handling, and it relates more particularly to a water feed device for feeding water to a moistener for moistening envelope flaps that is incorporated into a mail handling machine.

### PRIOR ART

Devices making it possible to feed water to moisteners in mail handling machines are well known, and conventionally such a device comprises a reserve stock of water mounted on a support and connected to a reservoir of water which is disposed under a conveyor table for conveying the envelopes, and in which a piece of foam dips in part. The envelopes are moistened as the flaps of the envelopes pass between the top surface of the moistened piece of foam and a brush placed immediately behind a separator for separating the flaps from the bodies of the envelopes.

Unfortunately, such a water feed device suffers from certain drawbacks. Such a device, which does not use any pumping means, has a single water-quantity setting that, by definition, cannot be adapted to all of the available types of envelope. As a result, the quality of sticking down is degraded for certain types of envelope. But above all, when the conveyor table is inclined towards a referencing wall, the moistener, which operates on the principle of communicating vessels, is not imbibed uniformly, and the flap of the envelope is thus not moistened uniformly over its width. In particular, if the level of water is defined so as to moisten properly the portion of the flap that is close to where it meets the body of the envelope, then the free portion or tip of the flap is not moistened correctly. Conversely, if the level of water is defined to moisten properly the tip of the flap, then the portion of the flap that is close to where it meets the body of the envelope is moistened abundantly, giving rise to water being deposited on the print rollers and then on the print zone, resulting in the postage imprint bleeding.

### OBJECT AND DEFINITION OF THE INVENTION

The present invention thus proposes a water feed device that mitigates those drawbacks and that makes it possible, in particular, to vary the quantity of water deposited depending on the shape and, in particular, on the width of the flaps. An object of the invention is to implement such a device without significantly modifying the current structure of mail handling machines.

These objects are achieved by a water feed device for feeding water to a moistener for moistening envelope flaps that is incorporated into a mail handling machine, the water feed device comprising a reserve stock of water from which a quantity of water flows to a reservoir of water, said quantity of water being suitable for imbibing a piece of foam dipping in said reservoir of water, said water feed device having at least two distinct water feed circuits for feeding water separately to at least two separate compartments of said reservoir of water from at least two isolated compartments of said reserve stock of water in a manner such as to define at least two distinct levels of water for the at least two isolated compartments of said reserve of water, and thus to define at least two different heights of water in the at least two corresponding separate compartments of said reservoir of water.

Thus, with this particular configuration, the quantity of water deposited on the flap of the envelope varies over the width of said envelope, thereby making it possible for the entire flap to be moistened uniformly.

Advantageously, said at least two separate compartments of said reservoir of water are disposed adjacently over the width of the flap and are separated by at least one longitudinal wall.

Preferably, said reserve of water is mounted on a compartmented support provided with at least two mutually independent shut-off valves that define two separate paths along which the water can flow from said reserve stock of water.

Advantageously, each of said shut-off valves extends to a respective depth into the isolated compartment of the support that it shuts off in the manner of a stopper and that has a low level defining an equilibrium level for the water flowing from said reserve stock of water through said shut-off valve.

### BRIEF DESCRIPTION OF THE DRAWING

The characteristics and advantages of the present invention appear more clearly from the following description given by way of non-limiting indication and with reference to the accompanying drawing, in which:

FIG. 1 is a cross-section view of a water feed device of the invention for feeding water to a moistener in a mail handling machine; and

FIG. 2 is a cross-section view of a prior art water feed device.

### DETAILED DESCRIPTION OF A PREFERRED EMBODIMENT

As shown in FIG. 2, a known feed device for feeding a moistening liquid to a moistener in a mail handling machine comprises a reserve stock of a moistening liquid 10 (preferably water) mounted on a support 12 and from which a quantity of moistening liquid flows through a delivery duct 14 for the purpose of imbibing a piece of foam or sponge 16 dipping in a reservoir of liquid 18 disposed under a conveyor table forming a support surface for the envelopes as they are conveyed through the mail handling machine. The conveyor table and the reservoir of liquid are inclined at an angle lying in the range 5° to 20°, and typically 6°, towards a referencing wall for putting the envelopes 20 into a reference position. The envelope flaps are moistened as they pass between the top surface of the foam imbibed with moistening liquid and a hinged brush 22 behind (relative to the direction in which the envelopes advance) a separator designed to separate the flap of each envelope from the body of said envelope. The reserve stock of moistening liquid 10 is easy to remove from its support 12 and can be replaced when the moistening liquid runs short.

Since operation of the device is governed by the principle of communicating vessels, and since the water reaches equilibrium in the horizontal plane, the inclination of the conveyor surface for conveying the envelopes obligatorily gives rise to the foam being imbibed differently over the width of said conveyor surface (see, in dashed lines, the level of water in the foam), thereby giving rise to non-uniform moistening of the flaps, in particular of the widest flaps.

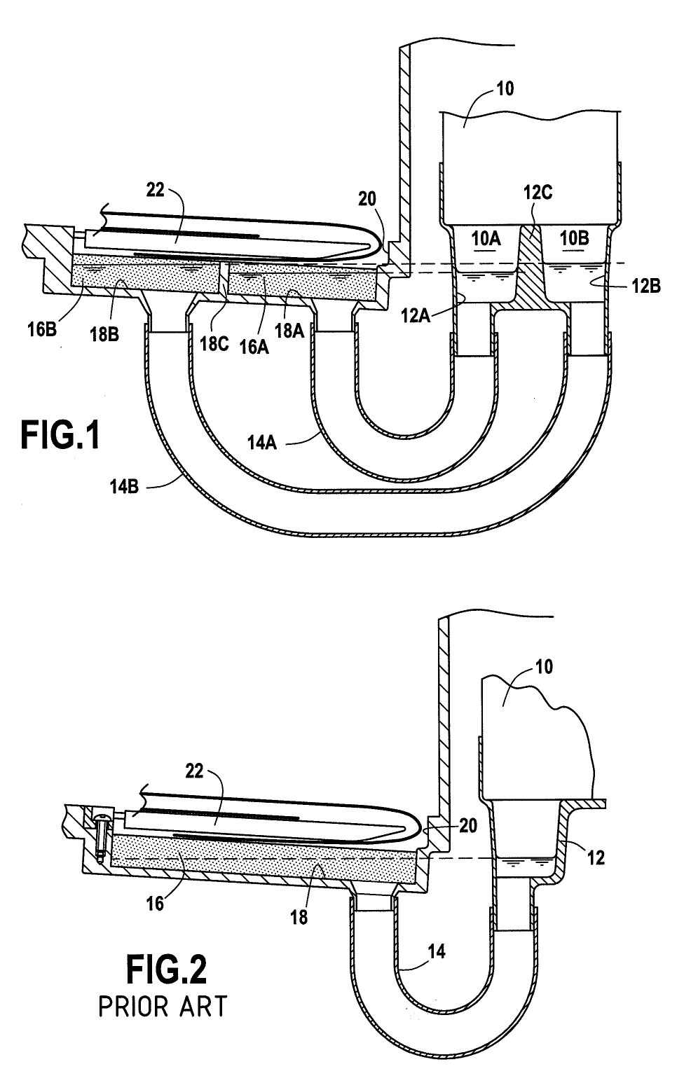

In accordance with the invention, and as shown in FIG. 1, in order to achieve uniform moistening, in particular of wide flaps, e.g. flaps that are of the triangular type, it is proposed to distribute the foam in at least two independent compartments 18A, 18B that are adjacent over the width of the flap. These two compartments are isolated from each other by a longitudinal wall 18C, and they are fed separately from respective ones of two delivery ducts 14A, 14B that are also separated from each other, each duct being connected at one end to the inlet orifice of a respective one of the two compartments and at the other end to a respective one of two outlet orifices in the common reserve stock of water.

The reserve stock of water 10 is mounted on a support 12A, 12B compartmented by a separation wall 12C and is provided with at least two mutually independent shut-off valves 10A, 10B that define two separate paths along which the water can flow towards the respective delivery ducts 14B, 14B leading to the two separate compartments 18A, 18B of the reservoir of water. More precisely, each shut-off valve extends to a respective determined depth into an isolated compartment 12A, 12B of the support that it shuts off in the manner of a stopper, and that has a low level defining an equilibrium level for the water flowing out from the reserve stock of water.

This split water feed thus makes it possible to define two distinct water levels (shown in dashed lines), one for each of the two compartments 12A, 12B of the support, and thus to define two different water heights in each of two corresponding compartments 18A, 18B of the water reservoir. Thus, the quantity of water available at the surface of the foam is more uniform and the resulting moistening is also more uniform. The postage imprint is no longer smudged or illegible, and no longer tends to bleed due to overabundance of water where the flap meets the envelope, as in prior art devices.

Naturally, the invention is not limited to the two-compartment configuration that is described above, and it is possible to imagine increasing the uniformity of moistening by adding additional equilibrium levels for the water by adding additional compartments to the reservoir of water, each of which is fed independently from as many separate compartments of the reserve stock of water.

What is claimed is:

1. A water feed device for feeding water to a moistener for moistening envelope flaps that is incorporated into a mail handling machine, the water feed device comprising a reserve stock of water from which a quantity of water flows to a reservoir of water, said quantity of water being suitable for imbibing a piece of foam dipping in said reservoir of water, said water feed device having at least two distinct water feed circuits for feeding water separately to at least two separate compartments of said reservoir of water from at least two isolated compartments of said reserve stock of water in a manner such as to define at least two distinct levels of water for the at least two isolated compartments of said reserve of water, and thus to define at least two different heights of water in the at least two corresponding separate compartments of said reservoir of water.

2. A water feed device according to claim 1, wherein said at least two separate compartments of said reservoir of water are disposed adjacently over the width of the flap and are separated by at least one longitudinal wall.

3. A water feed device according to claim 1, wherein said reserve of water is mounted on a compartmented support provided with at least two mutually independent shut-off valves that define two separate paths along which the water can flow from said reserve stock of water.

4. A water feed device according to claim 3, wherein each of said shut-off valves extends to a respective depth into the isolated compartment of the support that it shuts off in the manner of a stopper and that has a low level defining an equilibrium level for the water flowing from said reserve stock of water through said shut-off valve.
